(19) United States
(12) Patent Application Publication
(10) Pub. No.: US 2017/0045157 A1
(43) Pub. Date: Feb. 16, 2017

(54) PIPE SUPPORT PLATE

(71) Applicant: Zachariah Dale Boyles, Cushing, OK (US)

(72) Inventor: Zachariah Dale Boyles, Cushing, OK (US)

(21) Appl. No.: 15/227,050

(22) Filed: Aug. 3, 2016

Related U.S. Application Data
(63) Continuation of application No. 14/826,315, filed on Aug. 14, 2015, now abandoned.

(51) Int. Cl. F16L 3/02

(52) U.S. Cl. CPC F16L 3/02

(57) ABSTRACT

A pipe support plate configured to secure a bread-loaf type pipe support to a support structure to provide a greater level of safety and efficiency during the inspection repair, and maintenance of oil and gas pipelines. The pipe support plate includes a rounded bottom end, a rounded top end, and first and second sides extending between the rounded top end and the rounded bottom end and defining a plane. The plane includes an upper surface and a lower surface. The pipe support plate also includes a first curved edge member extending substantially perpendicularly from the first side and a second curved edge member extending substantially perpendicularly from the second side. The first curved edge member and the second curved edge member are configured to confine and secure a pipe support on the upper surface of the plane of the pipe support plate.

### CROSS REFERENCE TO RELATED APPLICATIONS

This application is a continuation of U.S. application Ser. No. 14/826,315 filed on Aug. 14, 2015.

### BACKGROUND

Pipelines enable the transport of crude and refined petroleum, fuels, such as oil, natural gas, and biofuels, and sewage, slurry, water, and various other fluids and gases. Pipelines are often made from a series of interconnected pipes formed from steel or plastic tubes. Pipelines may be buried below ground or elevated above ground, depending upon the type of good transported, the distance the pipeline is to carry the good, and the terrain, weather, and other environmental conditions. Pipelines that are built above ground are often secured to concrete, metal, or other types of support structures. One way to secure pipe to such an above ground support structure is through the use of ‘bread-loaf’ type pipe supports, such as those described in U.S. Pat. No. 6,863,248, issued to Calais et al.

Unfortunately, corrosion and other defects may cause the pipe to crack or wear, especially along points of contact between the pipe and the bread loaf type pipe support For example, variations in weather, temperature, flow dynamics, and other internal and external forces may cause the pipe to expand and contract causing damage. As a result, frequent inspections and repairs are often needed to maintain the pipeline in good working order.

To that end, it would be advantageous to provide a pipe support plate configured to safely secure a bread-loaf type pipe support to a support structure to reduce wear and tear on the pipe. It would also be advantageous to provide a pipe support plate with rounded ends and curved edges to allow persons to safely and easily adjust the pipe for inspections and repairs. It is to such a pipe support plate and to methods for using thereof that exemplary embodiments of the inventive concepts disclosed and claimed herein are directed.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings and appendices. In the drawings:

FIG. 1 is a perspective view of an exemplary embodiment of a pipe support plate according to the inventive concepts disclosed herein.

FIG. 2 is a perspective view of the pipe support plate of FIG. 1.

FIG. 3 is a perspective view of an embodiment of a pipe support plate according to the inventive concepts disclosed herein.

FIG. 4 is a perspective view of the pipe support plate of FIG. 3.

FIG. 5 is a perspective view of an embodiment of a pipe support plate according to the inventive concepts disclosed herein.

FIG. 6 is a perspective view of the pipe support plate of FIG. 5.

FIG. 7 is a perspective view of an embodiment of a pipe support plate according to the inventive concepts disclosed herein.

FIG. 8 is a perspective view of the pipe support plate of FIG. 7.

FIG. 9 is a perspective view of the pipe support plate of FIG. 7 showing a pipe and pipe support secured thereon.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises ” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed.

As used herein the notation “a-n” appended to a reference numeral is intended as merely convenient shorthand to reference one, or more than one, and up to infinity, of the element or feature identified by the respective reference numeral (e.g., 300a-n). Similarly, a letter following a reference numeral is intended to reference an embodiment of the feature or element that may be similar, but not necessarily identical, to a previously described element or feature bearing the same reference numeral (e.g., 310, 310a, 310b, etc.). Such shorthand notations are used for purposes of clarity and convenience only, and should not be construed to limit the instant inventive concept(s) in any way, unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference t “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The inventive concepts disclosed herein are generally directed to a pipe support plate comprised of a rounded bottom end, a rounded top end, and first and second sides extending between the rounded top end and the rounded bottom end defining a plane. The plane includes an upper surface and a lower surface. The pipe support plate includes a first curved edge member extending substantially perpendicularly from the first side and a second curved edge member extending substantially perpendicularly from the second side. The first curved edge member and the second curved edge member are configured to confine and secure a pipe support, such as a bread-loaf type pipe support, on the upper surface of the plane.

The pipe support plate is generally rectangular in shape and in some embodiments may be substantially square or circular in shape. Pipe support plates according to the inventive concepts disclosed herein are configured to be installed outdoors above-ground level and are configured to be attached to a support structure, such as a concrete slab, metal beam or wood beam.

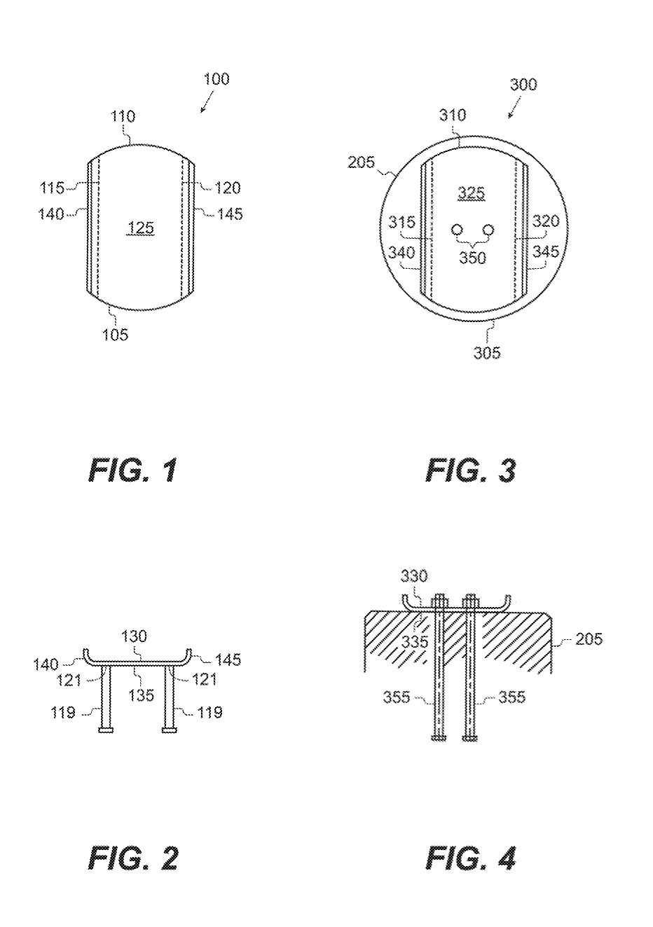

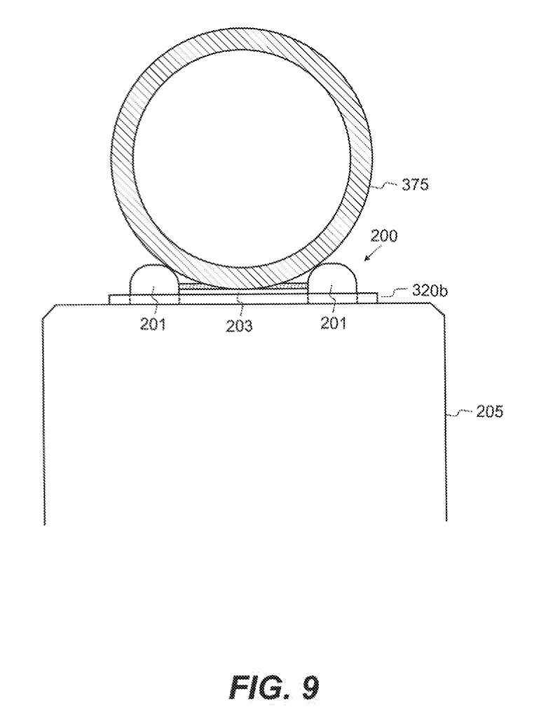

Referring now to FIGS. 1-2, shown therein is an exemplary embodiment of a pipe support plate 100 constructed according to the inventive concepts disclosed herein. The pipe support plate 100 is configured to be attached to a support structure 205 (shown in FIG. 3). The pipe support plate 100 includes a rounded bottom end 105 and a rounded top end 110. First and second sides 115 and 120 extending between the rounded top end 110 and the rounded bottom end 105 and defining a plane 125. As shown in FIG. 2, the plane 125 has an upper surface 130 and a lower surface 135. The pipe support plate 100 includes a first curved edge member 140 extending substantially perpendicularly from the first side 115 and a second curved edge member 145 extending substantially perpendicularly from the second side 120. The first curved edge ember 140 and the second curved edge member 145 are configured to confine and secure a pipe support 200 (as shown in FIG. 9) on the upper surface 130 of the plane 125.

The support structure 205 (as shown in FIGS. 3 and 4) may be any desired manmade structure or natural body or object. For example, the support structure 205 may be concrete, reinforced concrete, wood, plastic, rock, or any other type of structure able to secure the pipe support plate 100 and support the pipe.

The pipe support plate 100 includes a rounded bottom end 105, a rounded top end 110 and first and second sides 115 and 120 extending between the rounded top end 110 and the rounded bottom end 105 defining a plane 125. The plane 125 includes an upper surface 130 and a lower surface 135. The pipe support plate 100 may be implemented as a generally planar body and may be constructed of any desired material, including but not limited to, metals, alloys, non-metals, steel, titanium, carbon fiber, polymers, resins, ceramics, composite materials, or combinations thereof.

In some embodiments, the pipe support plate 100 may be generally rectangular in shape, while in some embodiments the pipe support plate 100 may be substantially square or circular in shape, as will be appreciated by persons of ordinary skill in the art having the benefit of the instant disclosure. Further, embodiments of the pipe support plate 100 may include reinforcing or bracing structures, such as struts, ribs, braces, rods, or any other suitable reinforcing structure, or combinations thereof.

The rounded bottom end 105 and rounded top end 110 are configured to allow persons to safely and efficiently inspect and repair the pipe. Straight edges, jagged edges, or other sharp corners and ends increase the risk of injury to persons during inspections and repair of the pipeline. The rounded bottom end 105 and rounded top end 110 may be rounded or curved at any desired angle sufficient to reduce or eliminate sharp corners and edges that may pose a risk to persons inspecting and repairing the pipe.

The pipe support plate 100 includes a first curved edge member 140 extending substantially perpendicularly from the first side and a second curved edge member 145 extending substantially perpendicularly from the second side 120. The first curved edge member 140 and the second curved edge member 145 are configured to confine and secure a pipe support 200 (as shown in FIG. 3 and 4) on the upper surface 130 of the plane 125.

The pipe support plate 100 is shown formed from a single piece of material. Preferably, the pipe support plate 100 may be formed from steel. However, the pipe support plate 100 may be formed from any type of material including metals, alloys non-metals, steel, titanium, carbon fiber, polymers, resins, ceramics, composite materials or combinations thereof. As one of ordinary skill in the art will appreciate, the the first curved edge member 140 and the second curved edge member 145 may also be formed from separate pieces of material and welded or otherwise connected to the first side 115 and the second side 120 respectively.

As shown in FIG. 2, the first curved edge member 140 extends substantially perpendicularly from the first side 115. As one of ordinary skill in the art will appreciate the angle at which the first curved edge member 140 extends from the plane 125 may be approximately 90° or any other angle sufficient to confine and secure a pipe support 200 (as shown in FIG. 9) on the upper surface 130 of the plane 125. Similarly, the second curved edge member 145 is shown extending substantially perpendicularly from the second side 120. As one of ordinary skill in the art will appreciate the angle at which the second curved edge member 145 extends from the plane 125 may be approximately 90° or any other angle sufficient to confine, retain, and secure a pipe support 200 (as shown in FIG. 9) on the upper surface 130 of the plane 125. For example, in some embodiments, the angle at which the first and second curved edge members 140 and 145 extend from the plane 125 may be at an angle of about 45°, or an angle varying between about 1° and about 45° between about 45° and about 90°, or between about 90° and about 180°.

To connect the pipe support plate 100 to a support structure, such as support structure 205 (as shown in FIG. 3), the pipe support plate 100 may be welded to connectors 119 (as shown in FIG. 2), such as metal headed shear connectors for example, to connect the pipe support plate 100 to a support structure, such as support structure 205. In some embodiments, the connectors 119 may be partially embedded or encased in concrete, wood, rock, or any other material used as a support structure. The concrete may be poured around the connectors 119 either before or after the pipe support plate 100 is welded or otherwise attached to the connectors 119.

Connectors 119, such as headed metal shear stud connectors are known to those of ordinary skill in the art and are commonly used in the concrete industry with both cast-in-place and pre-cast construction. Welding metal headed shear stud connectors 119 to the pipe support plate 100 provides an efficient and economical means of embedding a structural connection between the pipe support plate 100 and the support structure 205. The configuration size, and number of connectors 119 may be modified depending upon the desired strength of the attachment between the pipe support plate 100 and the sup port structure 205. As one of ordinary skill in the art will readily appreciate, other means of connecting the pipe support plate 100 to a support structure 205 are known in the art and may be utilized in accordance with the inventive concepts disclosed herein. It is to be appreciated that the pipe support plate 100 may be attached to the support structure 205, in any desired manner such as via welds, seams joints, screws, bolts, adhesives, or combinations thereof.

Further, the connectors 119 may be implemented as an elongated member (e.g., a beam, truss, leg, pin, or rod) and may include a connecting end 121 extending at least partially through the support structure 205. The connectors 119 being configured to attach the pipe support plate 100 to the support structure 205, as described herein. The connectors 119 may be formed from any desired material such as metals, alloys, non-metals, or combinations thereof, and may be connected or embedded to the support structure 205 in any desired manner such as concrete, welds, joints, seems, adhesives, fasteners, clamps, brackets, or combinations thereof. In some embodiments, the connectors 119 and the support structure 205 may be formed as a single unitary body, such as via casting, machining, molding, or any other desired method or technique.

While two connectors 119 are show, in FIG. 2, positioned adjacent to the first and second sides 115 and 120 respectively, embodiments of the inventive concepts disclosed herein may be implemented with any desired number of connectors 119 to be attached to the pipe support plate 100 at any desired location on the lower surface 135 of the pipe support plate 100, sufficient to secure the pipe support plate 100 to the support structure 205. For example, some embodiments of the inventive concepts disclosed herein may include a single connector 119, two connectors 119, three connectors 119, or four or more connectors 119 depending on the desired dimensions of the pipe support plate 100 and the structural integrity required to support the weight of the pipe and other pipeline components. As one of ordinary skill in the art will readily appreciate, the number and configuration of connectors 119, may be modified or adjusted as needed to safely attach the pipe support plate 100 to the support structure 205.

Referring now to FIGS. 3-4, shown therein is an embodiment of a pipe support plate according to the inventive concepts disclosed herein. FIGS. 3-4, show a pipe support plate 300. The pipe support plate 300 may be implemented similarly to the pipe support plate 100. The pipe support plate 300 includes a rounded bottom end 305, a rounded top end 310, and first and second sides 315 and 320 extending between the rounded top end and the rounded bottom end and defining a plane 325. The plane 325 includes an upper surface 330 and a lower surface 335. The pipe support plate 300 also includes a first curved edge member 340 extending perpendicularly from the first side 315 and a second curved edge member 345 extending perpendicularly from the second side 320. The first curved edge member 340 and the second curved edge member 345 are configured to confine and secure a pipe support 200 (as shown in FIG. 9) on the upper surface 330 of the plane 325. The pipe support plate 300 also includes a plurality of openings 350 extending through the plane 325. The plurality of openings 350 are configured for receiving anchor bolts 355 to connect the lower surface 335 of the plane 325 to a support structure 205.

While the plurality of openings 350 are shown as being substantially circular in shape, it is to be understood that the openings 350 may have any desired shape sufficient to matingly receive an anchor bolt 355, or other pin, bar, or connector, such that the anchor bolt 355 may be selectively inserted through the openings 350 of the plane 325. Once the anchor bolt 355 is inserted through the openings 350 the anchor bolt 355 may be secured and/or locked in place by a washer and nut or any other type of fastener or securing or locking mechanism known in the art.

As will be appreciated by persons of ordinary skill in the art having the benefit of the instant disclosure, any desired number of openings 350 may be implemented consistent with the inventive concepts disclosed herein. In some embodiments, a single opening 350 may be implemented, while in other embodiments, two or more openings 350, six or more openings 350, or nine or more openings 350, may be utilized. Also, as one of ordinary skill in the art will appreciate with benefit of the instant disclosure, in some embodiments the openings 350 may be omitted altogether.

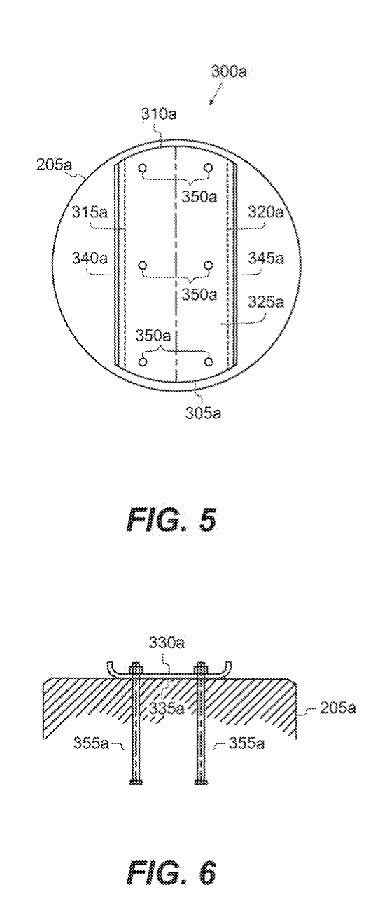

Referring now to FIGS. 5-6 shown therein is an embodiment of a pipe support plate according to the inventive concepts disclosed herein. FIGS, 5-6 show a pipe support plate 300a. The pipe support plate 300a may be implemented similarly to the pipe support plate 300 and the pipe support plate 100. The pipe support plate 300a includes a rounded bottom end 305a, a rounded top end 310a and first and second sides 315a and 320a extending between the rounded top end 310a and the rounded bottom end 305a defining a plane 325a. The plane 325a includes an upper surface 330a and a lower surface 335a. The pipe support plate 300a also includes a first curved edge member 340a extending perpendicularly from the first side 315a and a second curved edge member 345a extending perpendicularly from the second side 320a. The first curved edge member 340a and the second curved edge member 345a are configured to confine and secure a pipe support 200a (as shown in FIG. 9) on the upper surface 330a of the plane 325a. The pipe support plate 300a also includes a plurality of openings 350a extending through the plane 325a. The plurality of openings 350a are configured for receiving anchor bolts 355a to connect the lower surface 335a of the plane 325a to a support structure 205a.

The plurality of openings 350a are configured for receiving anchor bolts 355a to connect the lower surface 335a of the plane 325a to a support structure 205a. While the plurality of openings 350a are shown as being substantially circular in shape, it s to be understood that the plurality of openings 350a may have any desired shape sufficient to matingly receive an anchor bolt 355a such that the anchor bolt 355a may be selectively inserted through the plane 325a and/or locked to secure the pipe support plate 300a to the support structure 205a. As shown in FIG. 5-6 the pipe support plate 300a includes six openings 350a. The anchor bolts 355a extend through the plurality of openings 350a and are secured to the support structure 205a by a washer and nut, however, it should be understood that the anchor bolts 355a may be secured by any type of fastener or securing or locking mechanism known in the art.

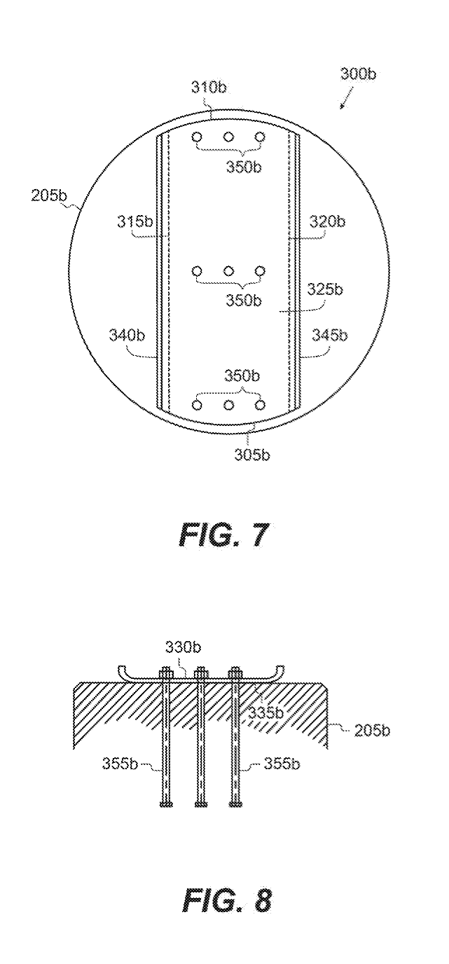

Referring now to FIGS. 7-8 shown therein is an embodiment of a pipe support plate 300b according to the inventive concepts disclosed herein. The pipe support plate 300b may be implemented similarly to the pipe support plate 100, the pipe support plate no and the pipe support plate 300a. The pipe support plate 300b includes a rounded bottom end 305b, a rounded top end 310b, and first and second sides 315b and 320b extending between the rounded top end 310b and the rounded bottom end 305b defining a plane 325b. The plane 325b includes an upper surface 330b and a lower surface 335b. The pipe support plate 30b also includes a first curved edge member 340b extending perpendicularly from the first side 315b and a second curved edge member 345b extending perpendicularly from the second side 320b. The first curved edge member 340b and the second curved edge member 345b are configured to confine and secure a pipe support 200 (as shown in FIG. 9) on the upper surface 330b of the plane 325b The pipe support plate 300b also includes a plurality of openings 350b extending through the plane 325b. The plurality of openings 325b are configured for receiving anchor bolts 355b to connect the lower surface 335b of the plane 325b to a support structure 205b.

The plurality of openings 350b are configured for receiving anchor bolts 355b to connect the lower surface 335b of the plane 325b to a support structure 205b. While the plurality of openings 350b are shown as being substantially circular in shape, it is to be understood that the plurality of openings 350b may have any desired shape sufficient to matingly receive an anchor bolt 355b such that the anchor bolt 355b may be selectively inserted through the plane 325b and/or locked to secure the pipe support plate 300b to the support structure 205b. As shown in FIGS. 7-8, the pipe support plate 300b includes nine openings 350b. The anchor bolts 355b extend through the plurality of openings 350b and are secured by a washer and nut, however it is to be understood that the anchor bolts 355b may be secured or locked to the support structure 205b by any type of fastener or locking or securing mechanism known in the art.

Referring now to FIG. 9, shown therein is an embodiment of a pipe support plate according to the inventive concepts disclosed herein. FIG. 9 shows a pipe support plate 300b in use with a pipe support plate 200 and a pipe 375. As disclosed above, the pipe support plate 300b may be implemented similarly to the pipe support plate 300a, the pipe support plate 300, and the pipe support plate 100. The pipe support plate 300b includes a rounded bottom end 305b, a rounded top end 310b and first and second sides 315b and 320b extending between the rounded top end and the rounded bottom end 305b defining a plane 325b. The plane 325b includes an upper surface 330b and a lower surface 335b. The pipe support plate 300b also includes a first curved edge member 340b extending perpendicularly from the first side 315b and a second curved edge member 345b extending perpendicularly from the second side 320b. The first curved edge member 340b and the second curved edge member 345b are configured to confine and secure a pipe support 200, such as a bread-loaf type pipe support, on the upper surface 330b of the plane 325b. The pipe support plate 300b also includes a plurality of openings 350b extending through the plane 325b. The plurality of openings 325b are configured for receiving anchor bolts 355b to connect the lower surface 335b of the plane 325b to a support structure 205b.

The pipe support plate 300b is shown in FIG. 9 in a secured position on a support structure 205. The pipe support 200 is shown on the upper surface 335b of the plane 325b and is secured by the first curved edge member 340b extending perpendicularly from the first side 315b and the second curved edge member 345b extending perpendicularly from the second side 320b.

The pipe support 200 is configured for supporting a pipe 375 along its longitudinal axis. The pipe support 200 is shown having a first and second longitudinally extending cylindrical support 201 and 202 supported on a transversely extending threaded rod 203. The first support 201 is fixed at one end of the transversely extending rod 203 and the second support 202 is movable along the rod 203 toward and away from the first support 201, so that the contact surface between the pipe 375 and the support 200 may be moved and adjusted to inspect the pipe 375 for corrosion or other defects.

The pipe support plate 320b is configured to support and confine the pipe support 200 to the support structure 205. Because the pipe support plate 320b is configured to be permanently or semi-permanently secured to the support structure 205, the pipe support 200 does not need to be permanently or semi-permanently fixed or secured to the support structure 205. This allows the pipe support 200 to be easily removed, inspected and/or adjusted and then repositioned and secured on the pipe support plate 320b, without having to change or modify the connection between the pipe support plate 320b and the support structure 205. In this way, the pipe support plate 320b permits a more efficient, safe, and accessible connection between the pipe 375 and the support structure 205. Further, because the pipe support plate 320b includes rounded ends and curved edges the pipe support plate 320b is configured to permit a user, such as a worker or inspector, to safely and efficiently adjust the pipe for inspections and repairs.

It is to be appreciated that the pipe support plate 100, 300, 300a and 300b may be installed and used with any desired type of pipe, pipe support, or pipe support structure. Further, the pipe support plate 100 300, 300a and 300b may be installed indoors or used underground or with existing or new pipeline structures.

Further the pipe support plate 100 300, 300a, and 300b may be shipped fully or partially assembled, or fully or partially disassembled in the form of a kit, as will be readily appreciated by persons of ordinary skill in the art having the benefit of the instant disclosure.

From the above description, it is dear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed is:

1. A pipe support assembly for above ground oil and gas pipelines, comprising:
a pipe support plate connected to a top portion of a support structure, the support structure positioned a distance above a ground surface, the pipe support plate comprising:
a rounded bottom end;
a rounded top end;
first and second sides extending between the rounded top end and the rounded bottom end and defining a flat plane, the flat plane having a flat upper surface and a flat lower surface;
a first curved edge member extending perpendicularly from the first side and a second curved edge member extending perpendicularly from the second side; and
a plurality of openings extending through the flat plane, the plurality of openings for receiving anchor bolts to connect the flat lower surface of the fiat plane to the support structure:
a pipe support positioned on the flat upper surface of the pipe support plate and confined and secured to the pipe support plate by the first and second curved edge members of the pipe support plate; and
a pipe for transportation of oil and gas products and byproducts, the pipe supported by and secured to the pipe support along the longitudinal axis of the pipe.

2. The pipe support assembly of claim 1, wherein the pipe support plate is connected to the support structure by anchor bolts.

3. The pipe support assembly of claim 1, wherein the pipe support plate is formed from a single piece of material.

4. The pipe support assembly of claim 1, wherein the pipe support plate is formed from steel.

5. The pipe support assembly of claim 1, wherein the plurality of openings extending through the flat plane consist of two openings.

6. The pipe support assembly of claim 1, wherein the plurality of openings extending through the flat plane consist of six openings.

7. The pipe support assembly of claim 1, wherein the plurality of openings extending through the flat plane consist of nine openings.
